(19) United States
(12) Patent Application Publication
(10) Pub. No.: US 2024/0019366 A1
(43) Pub. Date: Jan. 18, 2024

(54) Method for measuring solubilization of particles by living cells and/or the derived products thereof and associated kit

(71) Applicants: CENTRE NATIONAL DE LA RECHERCHE SCIENTIFIQUE, Paris (FR); ECOLE SUPERIEURE DE PHYSIQUE ET DE CHIMIE INDUSTRIELLES DE LA VILLE DE PARIS, Paris (FR); GOLD STANDARD DIAGNOSTICS MILLIDROP, NANTES (FR); FONDATION DE COOPERATION SCIENTIFIQUE - PARIS SCIENCES ET LETTRES PSL VALORISATION, Paris (FR)

(72) Inventors: Laurent BOITARD, ARGENTEUIL (FR); Denis COTTINET, MONTROUGE (FR); Riccardo BALZAN, VITRY SUR SEINE (FR); Jean BAUDRY, PARIS (FR); Ghilhem CHENON, PARIS (FR); Arthur GOLDSTEIN, PARIS (FR); Hicham FERHOUT, TOULOUSE (FR)

(21) Appl. No.: 18/037,525

(22) PCT Filed: Nov. 17, 2021
(86) PCT No.: PCT/EP2021/081918

§ 371 Date: May 17, 2023

(30) Foreign Application Priority Data
Nov. 17, 2020 (FR) 2011793

(51) Int. Cl. G01N 21/53

(52) U.S. Cl. CPC G01N 21/53

(57) ABSTRACT

The method comprises the following steps: —providing particles (49) to be solubilised in stable suspension, the particles (49) of a suspension being of identical chemical composition; —generating at least one drop (16) comprising at least one particle (49) to be solubilised of the stable suspension of particles (49) and a culture medium (50) that is able to contain at least one living cell (4) and/or at least one product derived from a living cell in suspension; —introducing the drop (16) into a tube (10); —incubating the drop (16) in the tube (10); —illuminating the tube (10) through an incident light beam; and —measuring, at various times, the quantity of light from the light beam scattered transversely to the incident beam by the drop (16) in the tube (10).

The present invention relates to a method for measuring solubilization of particles by living cells or the derived products thereof such as extracts, enzymes, culture supernatants, and metabolites.

Here, solubilization denotes any process that leads to the bringing into solution of a precipitate or a crystal or a solid. The physical and chemical processes that may be involved are for example, without being exhaustive, hydrolysis, degradation by modification of chemical function, catalysis or lysis, decomposition, chelation of ions or of counterions, change in pH, production of fats, amphiphilic molecules or alcohol, any chemical or physical change caused by the living cells or derivatives thereof that leads to reduction of the total mass of particles.

The scientific literature contains examples of microorganisms capable of effecting a chemical reaction, or of only developing in the presence of another microorganism (Stewart E J. Growing unculturable bacteria. J Bacteriol. 2012; 194(16):4151-60; Odom J M, Wall J D. Photoproduction of H2 from cellulose by an anaerobic bacterial coculture. Appl Environ Microbiol. 1983; 45 (4):1300-5; Zhang Q, He J, Tian M, Mao Z, Tang L, Zhang J, et al. Enhancement of methane production from cassava residues by biological pretreatment using a constructed microbial consortium. Bioresour Technol [Internet]. 2011; 102(19):8899-906).

Consortia are sometimes necessary for getting rid of compounds that are particularly chemically inert such as lignocellulose (Puentes-Tellez P E, Falkao Salles J. Construction of Effective Minimal Active Microbial Consortia for Lignocellulose Degradation. Microb Ecol. 2018; 76(2):419-29).

A method commonly used comprises the use of agar plates placed in Petri dishes and containing particles to be solubilized, for example particles of calcium phosphate. Individual cells are spread on the surface of the plates and they multiply until a cell colony is formed. The cell colonies are called clones; said colonies constitute a cluster of cells derived from an individual cell.

The cells are for example microorganisms such as bacteria, yeasts or filamentous fungi. The systems on plates make it possible to quantify and identify the cells.

The Petri dishes are incubated for between two and four days.

On a Petri dish, the phenomena of solubilization or of hydrolysis are generally detectable by a change in color or turbidity, typically by the formation of transparent halos around the colonies.

As examples of these methods, we may mention the documents Midgley et al., “Access to organic and insoluble sources of phosphorus varies among soil Chytridiomycota”, Archives of Microbiology (2006) 186:211-217, and Przemieniecki et al., “The effect of psychrotrophic bacteria isolated from the root zone of winter wheat on selected biotic and abiotic factors”, Journal of Plant Protection Research (2014) Vol. 54, No. 4.

However, a method of this kind is long, it is only based on a user's subjective observation, and is barely quantitative.

Furthermore, for the example of calcium phosphate, certain microorganisms dissolve calcium phosphate without forming a visible halo (see for example Nautiyal CS. An efficient microbiological growth medium for screening phosphate solubilizing microorganisms. FEMS Microbiol Lett [Internet]. 1999; 170(436):265-70).

Other methods aim to detect, by means of colored or fluorescent substrates, enzyme activities that are known to be involved in the solubilization or utilization of the target compound (phytate, chitin, cellulose etc.). These methods allow simple detection, because if the substrate is altered by the enzyme being studied, a change in color or fluorescence occurs, which is generally easy to detect by direct observation or in spectroscopy. However, the method can only target activities that are known and documented, as it depends on the existence of or substrate-specific synthesis of an enzyme or enzyme family.

The document O'Sullivan et al., “The effect of biomass density on cellulose solubilisation rates”, Bioresource Technology 99 (2008) 4723-4731 discloses indirect methods by determining the products and coproducts (gas and biomass) resulting from the solubilization and metabolization of cellulose.

Moreover, certain phenomena like the solubilization of calcium phosphate are not linked to an enzyme activity, but to the secretion of molecules, such as organic acids, for which no simple and specific method exists for detecting them.

The document Farhat et al., “Characterization of the mineral phosphate solubilizing activity of Serratia marcescens CTM 50650 isolated from the phosphate mine of Gafsa”, Archives of Microbiology (2009) 191:815-824 discloses the determination of soluble phosphorus or P₂O₅ of the supernatant by colorimetry.

The document US 2007/244050 A1 discloses measurement of solubilization performed on aggregates of proteins by the absorbance of ultraviolet light, by measuring the intensity transmitted in the direction of the beam incident on the sample.

The document Lowe et al., “Solubilisation, refolding and purification of eukaryotic proteins expressed in E. coli”, Protein Purification: Micro to Macro (1987) 429-442 describes the solubilization of proteins of the bacterium E. coli by using denaturants such as urea.

Finally, genomic and metagenomic approaches make it possible to search, by sequencing, for the presence of genes having sequences similar to genes known to be involved in the mobilization of the targeted compound. However, with this method, the search is again limited to what is already known, by looking for similarities, and this method does not guarantee that the genes thus detected are effectively expressed, expressible, or sufficient to achieve mobilization of the target compound for the microorganism.

Document U.S. Pat. No. 6,788,409 B2 discloses a flow cytometry method for testing the solubility of components. The sample passes through a flow cell traversed by a laser beam perpendicular to the flow. The geometry of the flow and of the beam is such that the particles pass through the beam individually and a flash can be detected for each of these objects.

The technique described in that document is not suitable for measuring solubilization over time and for incubation of numerous samples.

Document WO 2019/007674 A1 discloses a method of analysis and cell culture in a train of drops generated and circulated in a tube, the steps of the method being carried out in a controlled atmosphere.

One aim of the invention is to supply a method that makes it possible to discriminate, in a simple manner, living cells and/or the derived products thereof capable of solubilizing particles in various samples and for multiple applications.

For this purpose, the invention relates to a method for measuring solubilization of particles by at least one living cell and/or at least one derived product of a living cell, the method comprising the following steps:
supplying particles to be solubilized in stable suspension, the particles of a suspension being of identical chemical composition,
generating at least one drop comprising at least one particle to be solubilized of the stable suspension of particles and a culture medium that may contain at least one living cell and/or at least one derived product of a living cell in suspension,
introducing the drop into a tube,
incubating the drop in the tube,
   illuminating the tube with an incident light beam, and
   measuring, at different time points, the quantity of light of the light beam scattered transversely to the incident beam by the drop in the tube. The method for measuring solubilization of particles by at least one living cell and/or at least one derived product of a living cell according to the invention may comprise one or more of the following characteristic features, taken in isolation or in any combination technically possible:
the method further comprises comparison of the values obtained at the different time points for each drop, and at the end of this comparison, determining the presence or absence, in the drop, of living cells and/or of the derived products thereof capable of solubilizing the particle;
the method further comprises a step of measuring the quantity of living cells and/or of the derived products thereof present in the drop at the different time points;
the particles of the stable suspension are in suspension in an aqueous solution comprising at least one substance for stabilizing the suspension of particles;
the tube has an inside diameter between 0.1 mm and 3 mm;
at least 90% of the particles in the stable suspension have a radius between 10 nm and 10 μm, preferably between 100 nm and 500 nm;
at least one drop contains at least one particle to be solubilized of the stable suspension of particles and a culture medium containing at least one living cell and/or at least one derived product of a living cell in suspension;
   the method comprises generating a train of ordered drops in a carrying fluid, the train of drops comprising at least one drop comprising at least one particle to be solubilized in stable suspension and a culture medium that may contain at least one living cell and/or at least one derived product of a living cell in suspension;
the step of measuring the quantity of living cells and/or of the derived products thereof present in the drop at the different time points comprises measurement of a fluorescence signal associated with respiration or with alteration of the pH of the medium by the living cells and/or the derived products thereof present in the drop. The invention also relates to a kit suitable for carrying out the method of measurement according to the invention, comprising particles in stable suspension, the particles of a suspension being of identical chemical composition, a culture medium suitable for culturing living cells in suspension that are able to solubilize said particles and a system for culture of living cells and for measuring solubilization of particles by at least one living cell and/or at least one derived product of a living cell comprising at least:
a tube,
a module for generating a train of ordered drops in a carrying fluid,
a device for circulating the train of drops in the tube,
a device for incubating the train of drops in the tube, and
   a measuring device comprising a device for projecting an incident light beam onto the tube and measuring the quantity of light scattered transversely to the incident beam.

The kit according to the invention may comprise one or more of the following characteristic features, taken in isolation or in any combination technically possible:
the measuring device is suitable for measuring the quantity of living cells and/or of the derived products thereof present in a drop;
the particles in suspension are particles of hydroxyapatite in suspension in an aqueous solution comprising polyacrylate, and the culture medium comprises a sugar, ammonium sulfate, potassium chloride, magnesium sulfate, manganese sulfate and iron sulfate.
the culture medium lacks sugar or any other source of carbon and of energy, and in which the particles in suspension constitute the only source of carbon and of energy for growth of living cells;
the particles in suspension are particles of chitin, or the particles in suspension are particles of cellulose, or the particles in suspension are particles of lignin, or the particles in suspension are microplastic particles, or the particles in suspension are particles of polysaccharide.

The invention will be better understood on reading the description presented hereunder, given solely as an example, and referring to the appended drawings, in which:

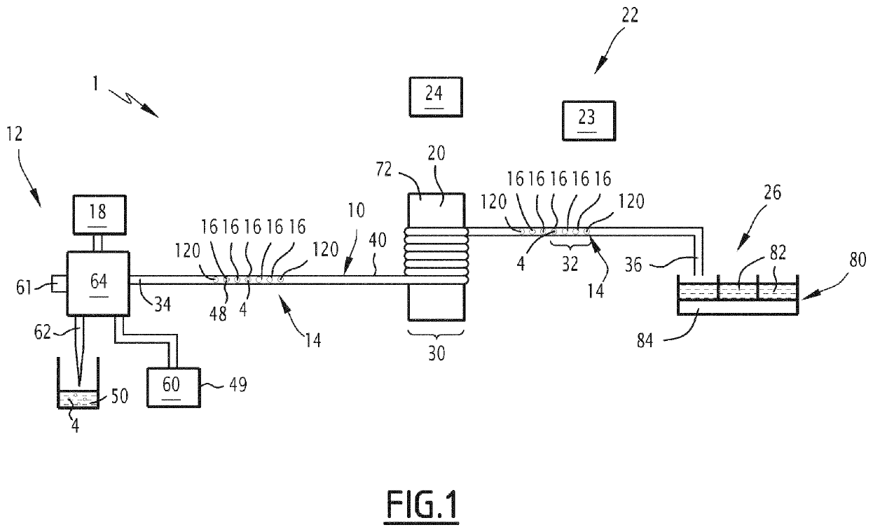

FIG. 1 is a schematic representation of a system for culture of living cells and for measuring solubilization of particles by living cells and/or the derived products thereof;

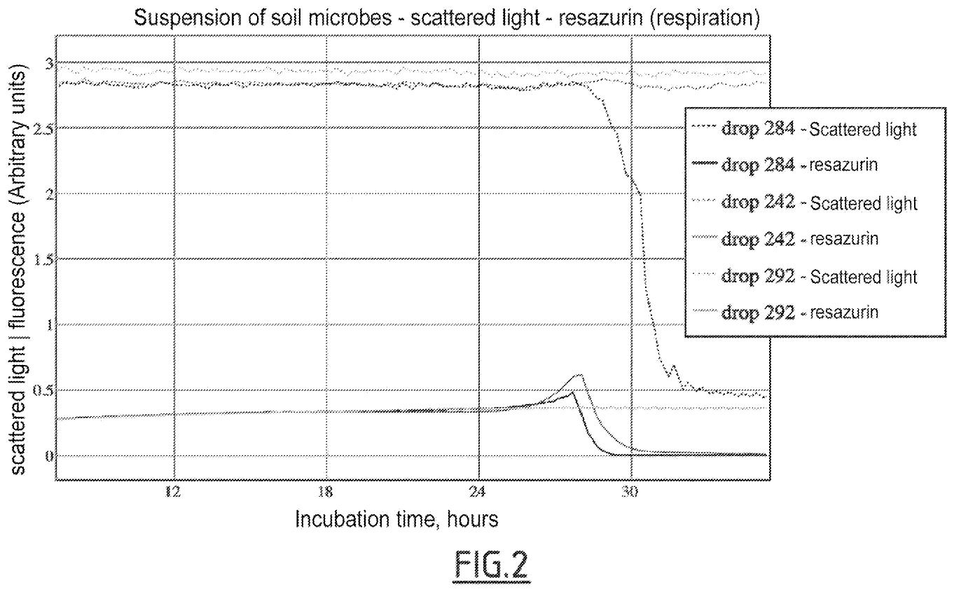

FIG. 2 is a diagram showing the variation in quantity of light scattered by drops transversely to an incident beam as well as the variation of fluorescence in the drops as a function of the incubation time, the light being projected through a tube comprising a plurality of drops, each drop comprising particles in suspension and a fluorescent marker, certain drops comprising at least one living cell and/or a derived product of a living cell capable of solubilizing the particles in suspension; and

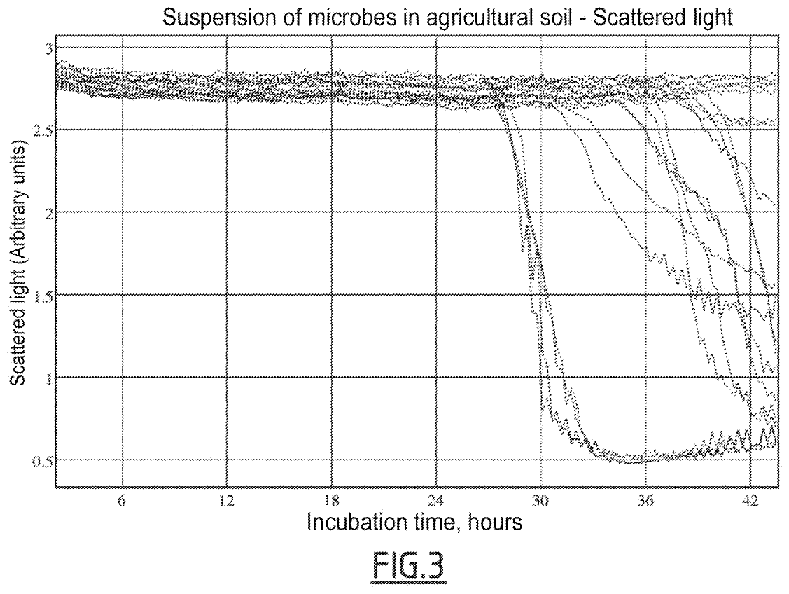

FIG. 3 is a diagram showing the variation in quantity of light scattered by drops transversely to an incident beam in the drops as a function of the incubation time, the light being projected through a tube comprising a plurality of drops, each drop comprising particles in suspension, certain drops comprising at least one living cell and/or a derived product of a living cell capable of solubilizing the particles in suspension.

FIG. 1 illustrates a system 1 for culture of living cells 4 and for measuring solubilization of particles by living cells 4 and/or the derived products thereof.

The living cells 4 are for example microorganisms.

The microorganisms are for example microorganisms of the soil, of the subsoil, of the human or animal intestinal microbiota, or genetically modified microorganisms, or marine microorganisms.

As nonlimiting examples, we may mention the following microorganisms: Bacillus amyloliquefaciens, Bacillus megaterium, Bacillus radicola, Bacillus subtilis, Clostridium subterminale, C. sordellii, C. sporogenes, C. indolis, C. bifermentans, C. mangenoti, C. perfringens, C. botulinum, C. tetani, Coniothyrium minitans, Desulfobacterium cathecholicum, Escherichia coli, Lactobacillus rhamnosus, Lactobacillus faciminis, Methanobacterium, Micrococcus cerificans, Mycobacterium vaccae, Pseudomonas aeruginosa, Pseudomonas spp, Rhizobium.

The microorganisms may contain several species or varieties or various clones. For example, the microorganisms may be prepared for parallel testing of the solubilization of the particles for clones or different species but evaluated individually. In another example, solubilization may be tested for mixtures of several clones or several species in order to test different combinations of these clones or of these species for solubilization.

The microorganisms are for example intended to be used for methods of bioproduction, for strategies of decontamination of water or soils, for fermentation in the food industry, and for biostimulation in agriculture.

The living cells 4 are for example animal cells.

The animal cells are for example osteoclasts. Investigation of solubilization of particles in the presence of animal cells may also allow investigation of the potential toxicity of materials or elimination of them by animal cells (Riediker et al. (2019), Particle Toxicology and health—where are we?, Particle and Fibre Toxicology 16, 19).

The products derived from living cells are for example extracts, enzymes, culture supernatants, and metabolites.

The enzymes are for example: cellulases (endocellulases, exocellulases, β-glucosidases, cellulose phosphorylases, pectinases, hemicellulases), ligninases, chitinases (chitodextrinase, 1,4-beta-poly-N-acetylglucosaminidase, poly-beta-glucosaminidase, beta-1,4-poly-N-acetylglucosamidinase, poly [1,4-(N-acetyl-beta-D-glucosaminide)] glycanohydrolase, (1→4)-2-acetamido-2-deoxy-beta-D-glucan glycanohydrolase), or peptidases, amylases, lipases, xylanases, glucanases.

The enzymes are for example used for methods of chemical synthesis, for cleaning products such as detergents or stain removers, for the food industry for modulating fermentation processes, for processing of vegetable raw material such as for papermaking, for converting starch, or as food supplements.

The system 1 comprises a tube 10, a generating module 12 of a train 14 of drops 16 intended to circulate in the tube 10, a circulating device 18 of the train 14 of drops 16 in the tube 10, an incubating device 20 of the train 14 of drops 16 in the tube 10, a measuring device 22 comprising a device 23 for projecting an incident light beam onto the tube and measuring the quantity of light scattered transversely to the incident beam, a central processing unit 24, and a recovery device 26.

The tube 10 is a capillary tube or fluidic tube at the millimeter scale, i.e. with an inside diameter of the order of tenths of a millimeter to millimeters, preferably between 0.1 and 3 mm.

The tube 10 is for example made of fluorinated ethylene polymer, such as fluorinated ethylene propylene, or polytetrafluoroethylene.

The tube 10 is transparent, so that it allows light to pass through it.

The tube 10 has an internal cross section of rounded contour, such as circular or elliptical, or polygonal such as rectangular.

The tube 10 has an incubating zone 30 and a measuring zone 32.

Furthermore, the tube 10 has an inlet end 34 and an outlet end 36.

The module 12 for generating a train 14 of drops 16 is suitable for generating a train 14 of drops 16. A train 14 of drops 16 is a succession of ordered drops 16 in a carrying fluid 40.

The carrying fluid 40 is, advantageously, an organic phase, in particular an oily phase. The carrying fluid 40 comprises, for example, perfluorocarbons such as FC-40 or hydrofluoroethers such as HFE-7500, forming a fluorinated oil. As a variant, the carrying fluid 40 comprises a silicone oil or an organic oil such as mineral oil.

The carrying fluid 40 is able to separate two successive drops 16 of the train 14 of drops 16.

The train 14 of drops 16 advantageously comprises separators 120. A separator 120 is a gas bubble.

The separator 120 promotes spacing between two successive drops 16 of the train 14 of drops 16 to prevent contact or coalescence of the drops 16.

In an example not shown, the train 14 of drops 16 comprises a separator 120 between each drop 16.

Each drop 16 of the train 14 of drops 16 constitutes a closed compartment filled with internal fluid 48.

Each drop 16 comprises an internal fluid 48 that is immiscible with the carrying fluid 40. Immiscible means that the partition coefficient between the two fluids is less than 10⁻³. The internal fluid 48 is, advantageously, an aqueous phase.

The volume of the drops 16 of the train 14 of drops 16 is, for example, between 1 nL and 1 mL, preferably between 100 nL and 4 μL, in particular approximately equal to 600 nL.

In one example, the volume of the drops 16 is approximately the same from one drop 16 to another.

Before incubation, each drop 16 comprises at least one particle to be solubilized 49 in stable suspension.

“Stable suspension” means that the density of particles near the surface for a suspension left to stand after dispersion does not decrease by more than 25% in 1 hour. For example, in one of the embodiments, the density of the suspension near the surface does not decrease by more than 1% in 40 minutes.

“Near the surface” means between 0 mm and 5 mm of the free upper surface of the suspension.

The stable suspension is made up of the particles 49 dispersed in an aqueous solution.

In the case when a drop 16 comprises a plurality of particles 49, the particles 49 of a drop 16 are of identical chemical composition. In other words, each drop 16 makes it possible to test the capacity of living cells 4 and/or of the derived products thereof to solubilize particles 49 of a single chemical composition.

The chemical composition of the particles 49 is selected according to the solubilization function studied in the living cells 4 and/or the derived products thereof.

Advantageously, the particles 49 selected are of sufficiently low solubility to remain in precipitated form but are able to be dissolved if there is a change of environment, for example appearance of enzymes able to hydrolyze the particles 49 or a change in pH.

For example, the particles to be solubilized 49 contain phosphate and allow discrimination of living cells or the derived products thereof capable of solubilizing phosphate.

As a variant, the particles to be solubilized contain chitin, phytate, cellulose, microplastics, lignocellulose, lignin, fatty chains or hydrocarbons, protein substances or peptides, or any other component whose solubilization by living cells and/or the derived products thereof is likely to be studied.

At least 90% of the particles in suspension have for example a radius between 10 nm and 10 μm.

Advantageously, at least 90% of the particles in suspension have a radius between 100 nm and 500 nm.

The radius of the particles is advantageously measured with a suitable granulometry instrument for example such as an instrument for measuring dynamic light scattering or laser diffraction.

The particle size is selected according to the material used, in particular taking into account its density and its refractive index.

To optimize the radius of the particles, the measuring device 22 used is also taken into account, on the basis of the theories of light scattering such as the Rayleigh, Lorentz, and Mie theories. In particular, the following are considered: the measuring angle relative to the incident beam, the polarization and the wavelength of the incident beam, and the numerical aperture of the optical system used for measuring the scattered light.

The suspension of particles comprises for example at least one substance for stabilizing the suspension of particles, and/or is adjusted to a suitable pH to delay particle aggregation.

The substance for stabilizing the suspension of particles is for example an antiaggregation agent.

The amount of antiaggregation agent necessary for stabilizing a suspension depends on the grain size of the particles and their total surface area per unit volume of the suspension.

The antiaggregation agent is for example a surfactant or a polymeric dispersant.

The composition of the suspension of particles and of the antiaggregation agents used must not adversely affect the survival or activity of the living cells 4 and/or of the derived products thereof. Their effect on the growth or survival of the living cells 4 may be verified independently of the measurement of solubilization by verifying whether addition of the substances at representative concentrations to a culture medium 50 alters the growth or the activity of the living cells 4 and/or of the derived products thereof.

The polymeric dispersant is for example polyacrylate in aqueous solution.

The polyacrylate used is selected with an average molecular weight (Mw) between 1 kDa and 100 kDa, in particular an average molecular weight of 15 kDa.

The concentration of antiaggregation agent in the suspension is advantageously between 30 mg/L and 400 mg/L for 1 g/L of particles, preferably between 35 mg/L and 350 mg/L for 1 g/L of particles.

For example, the concentration of antiaggregation agent in the suspension is between 35 mg/L and 3500 mg/L for 1 g/L of particles of hydroxyapatite of median diameter 400 nm.

Aggregation may also be delayed by chemical modification of the surface of the particles.

During preparation of the suspension of particles, the mixture is advantageously treated with an ultrasound probe to guarantee good dispersion of the particles. In particular, to prepare 20 mL of the suspension of particles of hydroxyapatite, ultrasound is applied at a frequency of 20 kHz for a power of 750 watts and a total energy applied of 550 joules.

Each drop 16 further comprises a culture medium 50.

The culture medium 50 is a liquid culture medium suitable for the survival and growth of the living cells, such as a buffered solution supplemented with culture nutrients, vitamins, electron donors and acceptors, and adapted according to the particles to be solubilized.

Buffered solution means in particular a solution whose pH is for example of 7.

According to a first example, the culture medium is a rich medium comprising a sugar, ammonium sulfate, potassium chloride, magnesium sulfate, manganese sulfate and iron sulfate.

The culture medium 50 further comprises for example sodium chloride, calcium chloride, sodium hydroxide and 2-(N-morpholino)ethanesulfonic acid.

According to a second example, the culture medium comprises cellulose nanofibrils, or chitin particles, in suspension as the only source of carbon and of energy.

According to a particular embodiment, each drop 16 comprises an agent that is an indicator of activity of the living cells and/or of the derived products thereof, for example of their aerobic or anaerobic respiration.

In the example presented, the indicator agent reveals the respiration of the living cell or cells present in the drop 16.

Respiration indicates the presence of aerobic living cells in the drop and thus discriminates the drops comprising organisms that are not solubilizers from the drops not comprising living cells using oxygen.

In fact, consumption of oxygen combined with absence of solubilization of the particle to be solubilized indicates the presence of living cells that are not capable of solubilizing the particle to be solubilized.

The respiration indicator is for example a colored indicator. The respiration indicator is for example resazurin.

In another example, the consumption of oxygen can be measured with an oxygen indicator, for example MitoXpress® Xtra (Luxcel Biosciences).

According to a particular embodiment, each drop 16 comprises a pH indicator.

The pH indicator reveals the acidification or alkalization of the drop caused by the presence of certain living cells. This measurement of pH may make it possible to discriminate different mechanisms of solubilization.

The pH indicator is for example a colored indicator. The pH indicator is, for example, pyranine.

In the same way as respiration, the acidification or alkalization of the drop indicates the presence of certain living cells in the drop and thus discriminates the drops comprising living cells that are not solubilizers from the drops not comprising living cells.

The possibility of counting the drops not containing detectable living cells, the drops containing detected living cells that are solubilizers and the drops containing detected living cells that are not solubilizers makes it possible to determine, for a sample analyzed, the total abundance of culturable living cells in drops and the relative abundances of living cells that are solubilizers and that are not solubilizers.

According to a particular embodiment, each drop 16 comprises an agent that is an indicator of activity of at least one derived product of a living cell.

For example, the indicator is a fluorescent substance that can be grafted with a covalent chemical bond on at least one constituent of the derived products.

The module 12 for generating the train 14 of drops 16 comprises a reservoir or a plurality of reservoirs 60, a sampling device 62 and an inlet circuit 64.

The generating module 12 further comprises an additional reservoir 61. The additional reservoir 61 comprises carrying fluid 40.

Each reservoir 60 comprises a fluid necessary for formation of the train 14 of drops 16.

For example, reservoirs 60 are different compartments of a microtiter plate. As a variant, the reservoirs 60 are test tubes such as Falcon® tubes or microtubes such as those sold by Eppendorf®.

A reservoir 60 comprises a suspension that may contain at least one living cell 4 and/or at least one derived product of a living cell.

In the case when the suspension comprises a plurality of living cells 4, the living cells may be of the same species or of different species.

A reservoir 60 comprises a stable suspension of particles 49 to be solubilized.

For example, a reservoir 60 comprises the culture medium 50. For example, other reservoirs 60 contain reagents to be put in the drop 16.

For example, a reservoir 60 comprises an oxygen indicator.

For example, a reservoir 60 comprises a pH indicator.

The sampling device 62 is able to take solutions from each of the reservoirs 60 so as to form a train 14 of ordered drops 16 in the carrying fluid 40.

The sampling device 62 is able to prepare the train of drops in the inlet circuit 64.

For example, the sampling device 62 comprises a robotized pipetting arm. As a variant or additionally, the sampling device 62 comprises an aspirating head. The use of a robotized sampling device 62 makes it possible to limit the space required for the manipulations.

For example, the sampling device 62 comprises a gas reservoir.

The gas reservoir serves, for example, for pressurizing the various reservoirs 60, 61 to facilitate sampling. For example, the sampling device 62 is able to inject a fluid into the inlet circuit 64 by forcing fluid from the reservoir 60, 61 by means of the gas, into the inlet circuit 64.

As a variant or additionally, the sampling device 62 comprises a suction pump placed at the outlet 36. The pump is able to aspirate the various fluids and put the reservoirs 60,61 under partial vacuum. For example, the pump is a compressor or a gerotor pump.

The inlet circuit 64 is connected to the inlet 34 of the tube 10. The inlet circuit 64 comprises a fragmentation device able to generate drops 16 from the sampled suspension and a carrying fluid 40.

For example, the inlet circuit 64 comprises a recess or a course facilitating fragmentation of the fluids and generation of the drops 16. As a variant, the inlet circuit 64 comprises a flow focusing junction, or a T junction.

The carrying fluid 40 is for example injected, at the level of the inlet circuit 64, along the aspirating tube 10 by the injecting device so as to form the drops 16 of the train of drops 16 by co-flow.

The circulating device 18 of the train 14 of drops 16 is able to displace the train 14 of drops 16 within the tube 10 from the inlet 34 to the outlet 36.

The circulating device 18 comprises, for example, a blowing unit and/or an aspirating unit.

The circulating device 18 is advantageously able to circulate the train 14 of drops 16 from the incubating zone 30 to the measuring zone 32 and then from the measuring zone 32 to the incubating zone 30. The drops 16 may thus be displaced in both directions in the tube 10.

For example, the measuring zone 32 is located downstream of the incubating zone 30. The circulating device 18 is able to transfer the drop 16 from the incubating zone 30 to the measuring zone 32 for measuring the parameter that is indicative of the contents of the drop 16. The circulating device 18 is also able to transfer the drop 16 from the measuring zone 32 to the incubating zone 30 to continue incubation of the drop 16.

The circulating device 18 is able to generate a flow of the train 14 of drops 16 and of carrying fluid 40 in the tube between 0.1 mL/h and 5 mL/h.

The incubating device 20 is able to control the temperature of the incubating zone 30 of the tube 10. For example, the incubating device 20 is able to heat or to cool the incubating zone 30 of the tube to a temperature between 4° C. and 100° C., for example between 20° C. and 50° C. and in particular to 28° C. In one example, for culturing and analyzing soil microorganisms, the temperature is adjusted to 28° C.

The incubating device 20 comprises a coil 72 that is temperature-controllable, the part of the tube 10 corresponding to the incubating zone 30 being wound around the coil 72. This winding makes it possible to reduce the overall dimensions necessary for a large incubation length.

For example, the length of the tube 10 wound in the incubating zone 30 is between 1 meter and 100 meters.

As a variant, the incubating device comprises a chamber delimited by heat insulating walls, a heating and cooling element such as a Peltier module, a fan for circulating the convection gas contained and a temperature probe.

The measuring device 22 is able to measure a parameter that is indicative of the contents of the drop in the tube 10 at the level of the measuring zone 32 at different time points.

These successive measurements make it possible to construct, for each drop 16, curves of solubilization kinetics of the particles 49 within the drop 16 over the course of incubation.

The parameters measured are for example light scattering by the contents of the drops 16, absorption of light by the contents of the drops 16, absorption followed by emission at a different wavelength called fluorescence emission, the lifetime of said fluorescence emission, refraction or reflection of light.

The measuring device 22 comprises a device 23 for projecting an incident light beam onto the tube and measuring the quantity of light scattered transversely to the incident beam.

The wavelength of the incident light is for example between 350 nm and 800 nm.

In one embodiment the incident beam is produced with a laser or a laser diode.

The projecting device 23 is able to perform a nephelometry measurement.

Nephelometry is a technique for measuring the turbidity of a medium and consists of measuring the light scattered transversely to the incident light.

The projecting device 23 comprises one or more sources emitting light beams, at least one lens, a filter, a diaphragm and at least one photon detector.

The photon detector is for example a photodiode, a photomultiplier tube (PMT), a camera equipped with a charge transfer sensor (CCD) or CMOS (“complementary metal-oxide-semiconductor”) technology, or any other photon flux sensor.

“Light scattered transversely to the incident beam” means light scattered in a direction different than that of the incident beam. For example, we may measure the light scattered at an angle relative to the incident beam of between 80° and 100°, in particular equal to 90°. Measurement of the scattered light may be performed by detecting the scattered light or by measuring the variation in intensity in the direction of the incident beam due to the scattered light.

The light is scattered by the entire contents of the drop passing through the incident beam, in particular the laser beam. Therefore the quantity measured is not associated with a particle 49 but with the entire contents of the space delimited by the intersection between the drop 16 and the incident beam.

The size of the drop 16 and the size of the incident beam do not allow detection of a flash for each particle 49.

The space delimited by the intersection between the drop 16 and the incident beam contains more than one particle 49; the measured quantity of scattered light is the sum of the quantities of light scattered by several particles 49 and several types of particles 49 in the drop 16.

In one embodiment, the light scattered in a solid angle centered on the angle at 90° of the incident beam is detected using a lens system whose numerical aperture is 0.5.

For example, the measuring device 22 is additionally able to perform an optical measurement, such as a fluorescence measurement, and/or an analysis of an image of a drop.

Advantageously, to associate the measurements with each drop 16, the measuring device 22 is able to measure at least one parameter discriminating the drops 16 from the other fluids circulating in the tube 10. This measurement may be used for counting the drops and identifying them.

Advantageously, the measuring device 22 is able to measure the quantity of living cells 4 and/or of derived products thereof present in a drop 16 at the different time points, for example by measuring a fluorescence signal from a fluorescent substance in the drop 16.

The signal may be altered by the respiration or by the change of pH of the medium by the living cells 4, or by an activity of the products derived from living cells, or directly by the growth of the living cells 4 present.

“Quantity of living cells 4 and/or of the derived products thereof present” means either the measurement of a parameter proportional to the number of living cells 4 and/or of the derived products thereof in the drop or the measurement of a parameter able to discriminate the drops containing at least one living cell 4 and/or a derived product of a living cell, from the drops that do not contain any of them.

For example, the use of resazurin, pyranine, fluorescein, MitoXpress® Xtra (Luxcel Biosciences) in the drops with one of the measurements associated with fluorescence offered in the measuring device makes it possible to discriminate the drops containing at least one living cell from the drops that do not contain any.

In one example, resazurin is used at a final concentration in the drop 16 between 0.1 μmol/L and 1 mmol/L, or between 10 μmol/L and 100 μmol/L and typically at 90 μmol/L.

In another example, fluorescein is used at a final concentration in the drop 16 between 50 nmol/L and 1 mmol/L or between 1 μmol/L and 100 μmol/L and typically 10 μmol/L.

For example, measurement of the natural fluorescence of the living cells makes it possible to evaluate the number of living cells in each drop.

In another example, for certain living cells, for example such as the microorganism S. cerevisiae, analysis of the images of each drop 16 acquired with a camera in the measuring device 22 makes it possible to evaluate the number of living microorganisms in each drop 16.

In another example, analysis of the color of the contents of the drops 16 makes it possible to evaluate the number of living cells, for example such as for the microorganism Chlamydomonas reinhardtii.

The central processing unit 24 comprises a memory and a microprocessor. The central processing unit 24 is able to record the data from the measuring device 22 for each drop 16 of the train 14 of drops 16.

Advantageously, the central processing unit 24 is able to analyze the measurements carried out for a drop 16 and control recovery of the drop 16 or continuation of incubation depending on the result of the analysis.

For example, the drop 16 may be recovered for identifying the living cells and/or the derived products thereof that it contains, or else for culturing them to obtain growth of a strain or of a consortium of microorganisms isolated in the drop.

The recovery device 26 is able to allow recovery of each drop 16 individually.

The recovery device 26 comprises, for example, a recovery vessel 80 comprising several compartments 82, and a displacing device 84 of the recovery vessel 80 relative to the outlet 36 of the tube 10 so that a fresh compartment 82 is placed opposite the outlet 36 of the tube for each drop 16 to be recovered.

The system 1 is included in a kit further comprising particles 49 in stable suspension, the particles 49 of a suspension being of identical chemical composition, and a culture medium 50 suitable for culturing living cells 4 in suspension that are able to solubilize said particles.

A method for measuring solubilization of particles 49 by at least one living cell and/or at least one derived product of a living cell will now be described.

The method comprises the following steps:
supplying particles 49 to be solubilized in stable suspension, the particles 49 of a suspension being of identical chemical composition,
generating at least one drop 16 comprising at least one particle to be solubilized 49 of the stable suspension of particles 49 and a culture medium 50 that may contain at least one living cell 4 and/or at least one derived product of a living cell in suspension,
introducing the drop 16 into a tube 10,
incubating the drop 16 in the tube 10,
illuminating the tube 10 with an incident light beam, and
   measuring, at different time points, the quantity of light of the light beam scattered transversely to the incident beam by the drop 16 in the tube 10.

Advantageously, the method further comprises supplying a system 1 for culturing living cells 4 and measuring solubilization of particles 49 by at least one living cell and/or at least one derived product of a living cell and generating a train 14 of ordered drops 16 in a carrying fluid 12.

The train 14 of drops 16 is generated by the module 12 for generating the train of drops.

For example, the train 14 of drops 16 is circulated at a flow rate of 1 mL/h.

The incubating zone 30 of the tube is maintained at a temperature of 28° C.

Incubation is carried out in the incubating zone 30 of the tube 10.

Incubation is carried out in successive phases; a measurement is performed at the end of each incubation phase.

Advantageously, each incubation phase takes 30 minutes.

For example, in total, incubation takes between 4 hours and 72 hours.

During the measuring step, the drop 16 is placed in the measuring zone 32. Measurement comprises nephelometry measurement in the drop 16.

The light emitting sources are advantageously set for emitting at a wavelength between 350 nm and 700 nm.

Advantageously, measurement further comprises a step of measuring the quantity of living cells and/or of the derived products thereof present in the drop 16 at the different time points, for example by measuring a fluorescence signal associated with respiration or with alteration of pH of the medium by the living cells 4 or with an activity of the products derived from living cells present.

Advantageously, measurement further comprises production of an image of the drop 16.

Advantageously, the method further comprises a step of comparing the values obtained at the different time points, and at the end of this comparison, determining the presence or absence, in the drop, of living cells 4 and/or of the derived products thereof capable of solubilizing the particle.

This step is for example executed by the central processing unit 24.

For example, when it is detected in the drop 16 that the particle 49 has been solubilized by at least one living cell and/or at least one derived product of a living cell, the drop 16 is recovered in the recovery vessel 80.

If the measurement corresponds to a selection criterion of the user for example when it is measured that the clone is still in the growth acceleration phase, the drop 16 is returned to the incubating zone 30 by the circulating device 18. The criterion is, for example, a final amount of biomass. For example, when it is detected that the drop 16 does not comprise living cells capable of solubilizing the particle 49, the drop 16 is evacuated. Similarly, if the measurement does not correspond to the user's selection criteria, the drop 16 is evacuated.

In another embodiment, the drops 16 are all retained in the incubating zone 30 and continue to pass into the measuring device 22 until the end of the experiment. At the end of the experiment, all of the drops 16 are sent to the recovery zone 26 where, depending on the solubilization detected for each drop 16, they are recovered in the recovery vessel 80 or evacuated.

Advantageously, the method comprises a prior step of calibration of the nephelometry measurements.

As they develop, the living cells 4 and the derived products thereof make the drop 16 opaque by scattering the light more and more. Conversely, the solubilized particles 49 scatter the light less and less.

It is necessary to ensure that the development of the living cells and/or of the derived products thereof does not falsify the measurement.

For this purpose, the suspension of particles 49 to be solubilized is formed into a drop 16 without the culture medium that may contain at least one living cell and/or at least one derived product of a living cell in suspension.

The quantity of light scattered transversely to the incident beam is measured.

A suspension of living cells 4 and/or of the derived products thereof cultured beforehand in the culture medium 50 envisaged for performing the measurements is put into a drop without the suspension of particles 49 to be solubilized.

Advantageously, the composition of the culture medium 50 is adjusted to have a yield, i.e. the maximum quantity of living cells that may grow in this medium, that allows the best possible detection of solubilization. The yield is adjusted by optimizing the quantity, in the medium, of a limiting species having an essential nutrient property. A limiting species whose nutrient property is different and independent of the nutrient property of the particles to be solubilized is selected. Optimization is achieved by measuring the growth of the living cells in the medium with different concentrations of the limiting species and without the particle to be solubilized 49. During the tests for optimizing the quantity of limiting species, if the particle to be solubilized 49 has a nutrient property essential to the growth of the living cells, its absence is compensated by adding, to the culture medium 50, a comparable soluble substitute or a minimum sufficient quantity of particles 49 so as not to limit the growth of the living cells.

The quantity of light scattered transversely to the incident beam is measured.

Preferably, the quantity of light scattered by the suspension of particles 49 alone is much greater than the quantity of light scattered by the suspension of living cells 4 and/or of the derived products thereof alone.

For example, the quantity of light scattered by the suspension of particles 49 is at least ten times greater than the quantity of light scattered by the suspension of living cells 4 and/or of the derived products thereof.

If the quantity of light scattered by the suspension of particles is less than or not much greater than the quantity of light scattered by the suspension of living cells 4 and/or derived products thereof, the concentration of the suspension of particles may be modified to adjust the light scattered by the particles without living cells or the derived products thereof. If this is not sufficient, the particle size or the measuring device 22 may be modified. For example, the modifications of the measuring device 22 may relate to the measuring angle relative to the incident beam, the polarization and the wavelength of the incident beam, and the numerical aperture of the optical system used for measuring the scattered light.

The method thus makes it possible to discriminate living cells and/or the derived products thereof capable of solubilizing particles in various samples and for multiple applications.

For example, soil samples or environmental samples for determining the activity of microorganisms of a particular environment, or samples of the human or animal intestinal microbiota, or for finding microorganisms capable of removing contaminating particles, or for finding microorganisms capable of solubilizing cellulose or lignin for production of bioethanol.

The method allows quick, accurate analysis of capacities for consumption or solubilization of insoluble compounds by living cells and/or the derived products thereof in a culture medium.

Measurement of several signals also makes it possible to monitor other physicochemical or biological parameters such as pH, cellular stress, activation of metabolic pathways, specific substrate consumption. These parameters may be correlated or compared with the solubilization activity over time. The time sequence of the activities or of the modifications of the medium may also be identified.

The combination of all these measurements during incubation makes it possible to discriminate living cells and/or the derived products thereof according to a large number of criteria and therefore provide better identification, classification or selection thereof.

### EMBODIMENT EXAMPLES OF THE METHOD ACCORDING TO THE INVENTION

### Example 1: Search for Living Cells and/or the Derived Products Thereof that are Solubilizers of Phosphate

1. Materials and Methods

1.1 Particles

The particles are particles of hydroxyapatite with these characteristics at pH 6.6:
Median diameter: 0.40 μm
Diameter of the first decile: 0.29 μm
Diameter of the ninth decile: 0.63 μm

The hydroxyapatite has a density of 3.8 and a refractive index between 1.630 and 1.667.

1.2 Polymeric Dispersant

The polymer used is polyacrylate in aqueous solution, of molecular weight 15 kDa per chain, or about 150 residues per chain. The concentration of polymeric dispersant is 350 mg/l, for 1 g/l of hydroxyapatite particles, of median diameter 400 nm. In particular, the polyacrylate used is supplied by Merck (reference Sigma-Aldrich 416037).

A concentration of polyacrylate of 35 mg/L also gives excellent results.

The amount of dispersant required for stabilizing a suspension depends on the grain size of the particles and their total surface area per unit volume of the suspension.

1.3 Culture Medium

Rich and conventional synthetic media were used for culture of the living cells. The rich medium used most is a variant of the Pikovskaya medium comprising less calcium phosphate:

TABLE 1
composition of the rich medium

| Ingredient | Amount in grams per liter |
|---|---|
| Yeast extract | 0.5 |
| Dextrose | 10 |
| Hydroxyapatite | 1 |
| Ammonium sulfate | 0.5 |
| Sodium chloride | 0.2 |
| Potassium chloride | 0.2 |
| Magnesium sulfate | 0.1 |
| Manganese sulfate | 1.10⁻⁴ |
| Iron sulfate | 1.10⁻⁴ |

The synthetic medium used most is as follows:

TABLE 2
composition of the synthetic medium

| Ingredient | Amount in grams per liter |
|---|---|
| (NH₄)₂SO₄ | 0.5 |
| NaCl | 0.2 |
| MgSO₄•7H₂O | 0.1 |
| KCl | 0.2 |
| MnSO₄•H₂O | 0.002 |
| FeSO₄•7H₂O | 0.002 |
| CaCl₂ | 0.083 |
| 2-(N-morpholino)ethanesulfonic acid hydrate | 3.2 |
| NaOH | 0.52 |
| Glucose | 3.6 |
| Hydroxyapatite | 1 |

1.4 Methods

A sample of living cells and/or of the derived products thereof from the soil is suspended in the rich medium given above. A train of drops is generated in a transparent tube by a MilliDrop Analyzer system by inoculating, in each drop, the suspension of microorganisms, the suspension of hydroxyapatite particles, and a solution of resazurin.

Each drop has a volume of about 600 nL.

The drops are incubated and a measurement is performed on each of the drops at about every 30 minutes, comprising a measurement of the quantity of light scattered transversely to a light ray incident on the tube, and a fluorescence measurement.

2. Results

The results are presented in FIG. 2, which shows the quantity of light scattered and the fluorescence as a function of the incubation time.

With these conditions, there is a clear decrease in the quantity of light scattered.

The signal from resazurin indicates that drops 242 and 284 comprise at least one aerobic living cell, in contrast to drop 292, whose curve remains approximately constant.

Only drop 284 causes the quantity of light scattered to decrease, which indicates that it comprises at least one living cell and/or at least one derived product of a living cell capable of solubilizing phosphate.

The microorganism or microorganisms present in drop 292 are not capable of solubilizing phosphate.

The decrease in the quantity of light scattered caused by the solubilization of the hydroxyapatite particles is ten times greater than the increase in this signal caused by microbial growth.

According to the result, the drops may or may not be recovered to continue analysis of the microorganisms that they contain.

FIG. 3 shows the quantity of light scattered by nineteen drops as a function of the incubation time. Some drops comprise living cells and/or the derived products thereof capable of solubilizing phosphate after about thirty hours of incubation, and others comprise living cells and/or the derived products thereof capable of solubilizing phosphate after a longer time, for example between about forty and forty-five hours of incubation.

For the remaining drops, it is not possible to distinguish the drops comprising living cells and/or the derived products thereof that are not solubilizers of phosphate from the drops not comprising living cells and/or derived products thereof.

### Example 2: Search for Microorganisms and/or Living Cells and/or Derivatives Thereof that are Solubilizers of Chitin

1. Materials and Methods

1.1 Particles and Culture Medium

Chitin particles are prepared by dissolution in concentrated acid (HCl) and then re-precipitation (by the method of: Murthy N, Bleakley B. Simplified Method of Preparing Colloidal Chitin Used For Screening of Chitinase-Producing Microorganisms. 2012; 10(2):1-5).

These particles, with a diameter less than 5 μm, can be incorporated in drops, and scatter light transversely to the incident beam. The chitin particles are incorporated in a sugar-free culture medium.

TABLE 3
composition of the medium containing chitin

| Ingredient | Amount in grams per liter |
|---|---|
| Chitin | 15 |
| Yeast extract | 0.5 |
| (NH₄)₂SO₄ | 1.0 |
| MgSO₄•7H₂O | 0.3 |
| KH₂PO₄ | 1.36 |

1.2 Methods

The methods are identical to those in example 1.

2. Results

The living cells and/or derived products thereof capable of hydrolyzing chitin cause the quantity of light scattered to decrease, similarly to the particles of phosphate.

### Example 3: Search for Living Cells and/or Derived Products Thereof that are Solubilizers of Cellulose

1.1 Particles and Culture Medium

Cellulose nanofibrils in suspension are available commercially. A lean culture medium is prepared containing these nanofibrils as the only source of carbon and of energy.

TABLE 4
composition of the medium containing cellulose nanofibrils

| Ingredient | Amount in grams per liter |
|---|---|
| Na₂HPO₄ | 6.78 |
| KH₂PO₄ | 3 |
| NH₄Cl | 1 |
| NaCl | 0.5 |
| MgSO₄ | 0.06 |
| Cellulose | 3.6 |

1.2 Methods

The methods are identical to those in example 1.

2. Results

Similarly to chitin, the living cells and/or the derived products thereof capable of hydrolyzing cellulose cause the quantity of light scattered to decrease.

1. A method for measuring solubilization of particles (by at least one living cell and/or at least one derived product of a living cell, the method comprising the following steps:
supplying particles to be solubilized in stable suspension, the particles of a suspension being of identical chemical composition,
generating at least one drop comprising at least one particle to be solubilized of the stable suspension of particles and a culture medium that may contain at least one living cell and/or at least one derived product of a living cell in suspension,
introducing the drop into a tube,
incubating the drop in the tube,
illuminating the tube with an incident light beam, and
measuring, at different time points, the quantity of light of the light beam scattered transversely to the incident beam by the drop in the tube.

2. The method of measurement as claimed in claim 1, further comprising comparison of the values obtained at the different time points for each drop, and at the end of this comparison, determining the presence or absence, in the drop, of living cells and/or of the derived products thereof capable of solubilizing the particle.

3. The method of measurement as claimed in claim 1 or 2, further comprising a step of measuring the quantity of living cells and/or of the derived products thereof present in the drop (16) at the different time points.

4. The method of measurement as claimed in claim 1, in which the particles of the stable suspension are in suspension in an aqueous solution comprising at least one substance for stabilizing the suspension of particles.

5. The method of measurement as claimed in claim 1, in which the tube has an inside diameter between 0.1 mm and 3 mm.

6. The method of measurement as claimed in claim 1, in which at least 90% of the particles in the stable suspension have a radius between 10 nm and 10 m, preferably between 100 nm and 500 nm.

7. The method of measurement as claimed in claim 1, in which at least one drop contains at least one particle to be solubilized of the stable suspension of particles and a culture medium containing at least one living cell and/or at least one derived product of a living cell in suspension.

8. The method of measurement as claimed in claim 1, comprising generating a train of ordered drops in a carrying fluid, the train of drops comprising at least one drop comprising at least one particle to be solubilized in stable suspension and a culture medium that may contain at least one living cell and/or at least one derived product of a living cell in suspension.

9. The method of measurement as claimed in claim 3, in which the step of measuring the quantity of living cells and/or of the derived products thereof present in the drop at the different time points comprises measurement of a fluorescence signal associated with respiration or with alteration of the pH of the medium by the living cells and/or the derived products thereof present in the drop.

10. A kit suitable for carrying out the method of measurement as claimed in claim 1, comprising particles in stable suspension, the particles of a suspension being of identical chemical composition, a culture medium suitable for culturing living cells in suspension that are able to solubilize said particles and a system for culture of living cells and for measuring solubilization of particles by at least one living cell and/or at least one derived product of a living cell comprising at least:
a tube,
a module for generating a train of ordered drops in a carrying fluid,
a circulating device of the train of drops in the tube,
an incubating device of the train of drops in the tube, and
a measuring device comprising a device for projection of an incident light beam onto the tube and measuring the quantity of light scattered transversely to the incident beam.

11. The kit as claimed in claim 10, in which the measuring device is suitable for measuring the quantity of living cells and/or of the derived products thereof present in a drop.

12. The kit as claimed in claim 10, in which the particles in suspension are particles of hydroxyapatite in suspension in an aqueous solution comprising polyacrylate, and the culture medium comprises a sugar, ammonium sulfate, potassium chloride, magnesium sulfate, manganese sulfate and iron sulfate.

13. The kit as claimed in claim 10, in which the culture medium lacks sugar or any other source of carbon and of energy, and in which the particles in suspension constitute the only source of carbon and of energy for growth of living cells.

14. The kit as claimed in claim 13, in which the particles in suspension are particles of chitin, or the particles in suspension are particles of cellulose, or the particles in suspension are particles of lignin, or the particles in suspension are microplastic particles, or the particles in suspension are particles of polysaccharide.
